(19) United States
(12) Patent Application Publication
(10) Pub. No.: US 2020/0151019 A1
(43) Pub. Date: May 14, 2020

(54) OPU-based CNN acceleration method and system

(71) Applicant: REDNOVA INNOVATIONS,INC., Chengdu (CN)

(72) Inventors: Yunxuan Yu, Chengdu (CN); Mingyu Wang, Chengdu (CN)

(73) Assignee: REDNOVA INNOVATIONS,INC.

(21) Appl. No.: 16/743,066

(22) Filed: Jan. 15, 2020

(30) Foreign Application Priority Data
Mar. 14, 2019 (CN) 201910192502.1

(51) Int. Cl. G06F 9/50; G06N 3/08; G06F 9/30; G06N 20/10

(52) U.S. Cl. CPC G06F 9/5066; G06N 3/08; G06N 20/10; G06F 9/30072; G06F 9/5027

(57) ABSTRACT

An OPU-based CNN acceleration method and system are disclosed. The method includes (1) defining an OPU instruction set; (2) performing conversion on deep learning framework generated CNN configuration files of different target networks through a complier, selecting an optimal mapping strategy according to the OPU instruction set, configuring mapping, generating instructions of the different target networks, and completing the mapping; and (3) reading the instructions into the OPU, and then running the instruction according to a parallel computing mode defined by the OPU instruction set, and completing an acceleration of the different target networks. The present invention solves the problem that the existing FPGA acceleration aims at generating specific individual accelerators for different CNNs through defining the instruction type and setting the instruction granularity, performing network reorganization optimization, searching the solution space to obtain the mapping mode ensuring the maximum throughput, and the hardware adopting the parallel computing mode.

### CROSS REFERENCE OF RELATED APPLICATION

The present invention claims priority under 35 U.S.C. 119(a-d) to CN 201910192502.1, filed Mar. 14, 2019.

### BACKGROUND OF THE PRESENT INVENTION

### Field of Invention

The present invention relates to the field of FPGA-based (Field Programmable Gate Array-based) CNN (Convolutional Neural Network) acceleration method, and more particularly to an OPU-based (Overlay Processing Unit-based) CNN acceleration method and system.

### Description of Related Arts

Deep convolutional neural networks (DCNNs) exhibit high accuracy in a variety of applications, such as visual object recognition, speech recognition, and object detection. However, their breakthrough in accuracy lies in the high computational cost, which requires acceleration of computing clusters, CPUs (Graphic Processing Units) and FPGAs. Among them, FPGA accelerators have advantages of high energy efficiency, good flexibility, and strong computing power, making it stand out in CNN deep applications on edge devices such as speech recognition and visual object recognition of smartphones. The FPGA accelerators usually involve architecture exploration and optimization, :RTL (Register Transfer Level) programming, hardware implementation and software-hardware interface development. With the development of technology, FPGA accelerators for CNN has been deeply studied, which builds the bridge between FPGA design and deep learning algorithm developers, so as to allow the FPGA platform to be an ideal choice for edge computing. However, with the development of DNN (Deep Neural Network) algorithms in various more complex computer vision tasks, such as face recognition, license plate recognition and gesture recognition, multiple DNN cascade structures are widely used to obtain better performance. These new application scenarios require sequential execution of different networks. Therefore, it is required to constantly reconfigure the FPGA device, which results in long time-consumption. On the other hand, every new update in the customer network architecture can lead to the regeneration of RTL codes and the entire implementation process, which has a longer time-consumption.

In recent years, automatic accelerator generators which are able to quickly deploy CNN to FPGAs have become another focus. In the prior art, researchers have developed Deep weaver, which maps CNN algorithms to manual optimized design templates according to resource allocation and hardware organization provided by design planners. A compiler based on the RTL module library has been proposed, which comprises multiple optimized hand-coded Verilog templates that describe the computation and data flow of different types of layers. Researchers also have provided an HLS-based (High level synthesis) compiler that focuses on bandwidth optimization through memory access reorganization; and researchers also have proposed a -Systolic array architecture to achieve higher FPGA operating frequency. Compared with custom-designed accelerators, these existing designs have achieved comparable performance; However, existing FPGA acceleration work aims to generate individual accelerators for different CNNs, respectively, which guarantees reasonable high performance of RTL-based or HLS-RTL-based templates, but the hardware update is high in complexity when the target network is adjusted. Therefore, there is a need for a general method for deploying CNN to an FPGA, which is unnecessary to generate specific hardware description codes for a separate network and does not involve re-burning the FPGA. The entire deployment process relies on instruction configuration.

### SUMMARY OF THE PRESENT INVENTION

An object of the present invention is to provide an OPU-based CNN acceleration method and system, which is able to solve the problem that the acceleration of the existing FPGA aims at generating specific individual accelerators for different CNNs, respectively, and the hardware upgrade has high complexity and poor versatility when the target network changes.

The present invention adopts technical solutions as follows.

An OPU-based (Overlay Processing Unit-based) CNN (Convolutional Neural Network) acceleration method, which comprises steps of:

(1) defining an OPU instruction set to with optimized instruction granularity according to CNN network research results and acceleration requirements;

(2) performing conversion on CNN definition files of different target networks through a complier, selecting an optimal mapping strategy according to the OPU instruction set, configuring mapping, generating instructions of the different target networks, and completing the mapping; and

(3) reading the instructions into the OPU, and then running the instruction according to a parallel computing mode defined by the OPU instruction set, and completing an acceleration of the different target networks, wherein:

the OPU instruction set comprises unconditional instructions which are directly executed and provides configuration parameters for conditional instructions and the conditional instructions which are executed after trigger conditions are met;

the conversion comprises file conversion, network layer reorganization, and generation of a unified IR (Intermediate Representation);

the mapping comprises parsing the IR, searching the solution space according to parsed information to obtain a mapping strategy which guarantees a maximum throughput, and expressing the mapping strategy into an instruction sequence according to the OPU instruction set, and generating the instructions of the different target networks.

Preferably, the step of defining the OPU instruction set comprises defining the conditional instructions, defining the unconditional instructions and setting the instruction granularity, wherein:

defining conditional instructions comprises:

(A1) building the conditional instructions, wherein the conditional instructions comprise read storage instructions, write storage instructions, data fetch instructions, data post-processing instructions and calculation instructions;

(A2) setting a register unit and an execution mode of each of the conditional instructions, wherein the execution mode is that each of the conditional instructions is executed after a hardware programmed trigger condition is satisfied, and the register unit comprises a parameter register and a trigger condition register; and

(A3) setting a parameter configuration mode of each of the conditional instructions, wherein the parameter configuration mode is that the parameters are configured according to the unconditional instructions;

defining the unconditional instructions comprises:

(B1) defining parameters of the unconditional instructions; and

(B2) defining an execution mode of each of the unconditional instructions, wherein the execution mode is that the unconditional instructions are directly executed after being read.

Preferably, setting the instruction granularity comprises setting a granularity of the read storage instructions that n numbers are read each time, here, n>1; setting a granularity of the write storage instructions that n numbers are written each time, here, n>1; setting a granularity of the data fetch instructions to a multiple of 64, which means that 64 input data are simultaneously operated; setting a granularity of the data post-processing instructions to a multiple of 64; and setting a granularity of the calculation instructions to 32.

Preferably, the parallel computing mode comprises steps of:

(C1) selecting a data block with a size of IN×IM×IC every time, reading data from an initial position from one kernel slice, wherein ICS data are read every time, and reading all positions corresponding to the first parameter of the kernel multiplied by stride x till all pixels corresponding to the initial position of the kernel are calculated; and

(C2) performing the step of (C1) for Kx×Ky×(IC/ICS)×(OC/OCS) times till all pixels corresponding to all positions of the kernel are calculated.

Preferably, performing conversion comprises:

(D1) performing the file conversion after analyzing a form of the CNN definition files, compressing and extracting network information of the CNN definition files;

(D2) performing network layer reorganization, obtaining multiple layer groups, wherein each of the layer groups comprises a main layer and multiple auxiliary layers, storing results between the layer groups into a DRAM (Dynamic Random Access Memory), wherein data flow between the main layer and the auxiliary layers is completed by on-chip flow, the main layer comprises a convolutional layer and a fully connected layer, each of the auxiliary layers comprises a pooling layer, an activation layer and a residual layer; and

(D3) generating the IR according to the network information and reorganization information.

Preferably, searching the solution space according to parsed information to obtain the mapping strategy which guarantees the maximum throughput of the mapping comprises:

(E1) calculating a peak theoretical value through a formula of T=f×TN_{PE},

here, T represents a throughput capacity that is a number of operations per second, f represents a working frequency, TN_{PE} represents a total number of processing element (each PE performs one multiplication and one addition of chosen data representation type) available on a chip;

(E2) defining a minimum value of time L required for an entire network calculation through a formula of:

$$L = {minimize}_{{α}_{i}} Σ \frac{{C}_{i}}{{α}_{i} \times T} ,$$

here, αᵢ represents a PE efficiency of an i^{th} layer, Cᵢ represents an operational amount required to complete the i^{th} layer;

(E3) calculating the operational amount required to complete the i^{th} layer through a formula of:

Cᵢ=Nₒᵤₜⁱ×Mₒᵤₜⁱ×(2×Cᵢₙⁱ×Kᵢₙⁱ×K_{y}ⁱ−1)×Cₒᵤₜⁱ,

here, Nₒᵤₜⁱ, Mₒᵤₜⁱ, Cₒᵤₜⁱ represent output height, width and depth of corresponding layers, respectively, Cᵢₙⁱ represents a depth of an input layer, Kₓⁱ and K_{y}ⁱ represent weight sizes of the input layer, respectively;

(E4) defining αᵢ through a formula of:

$${α}_{i} = \frac{{C}_{i}}{{t}_{i} \times {N}_{PE}} ,$$

here, tᵢ represents time required to calculate the i^{th} layer;

(E5) calculating tᵢ through a formula of:

$${t}_{i} = ceil ( \frac{{N}_{in}^{i}}{{IN}_{i}} ) \times ceil ( \frac{{M}_{in}^{i}}{{IM}_{i}} ) \times ceil ( \frac{{C}_{in}^{i}}{{IC}_{i}} ) \times ceil ( \frac{{C}_{out}^{i}}{{OC}_{i}} ) \times ceil ( \frac{{IC}_{i} \times {OC}_{i} \times {ON}_{i} \times {OM}_{i} \times {K}_{x} \times {K}_{y}}{{N}_{PE}} )$$

here, Kx×Ky); represents a kernel size of the layer, ONᵢ×OMᵢ represents a size of an output block, ICᵢ×OCᵢ represents a size of an on-chip kernel block, Cᵢₙⁱ represents the depth of the input layer, Cₒᵤₜⁱ represents the depth of the output layer, Mᵢₙⁱ and Nᵢₙⁱ represent size of the input layer, INᵢ and IMᵢ represent size of the input block of the input layer; and

(E6) setting constraint conditions of related parameters of αᵢ, traversing various values of the parameters, and solving a maximum value of αᵢ through a formula of:

maximize

INᵢ, IMᵢ, ICᵢ, OCᵢ αᵢ

INᵢ×IMᵢ≤depthₜₕᵣₑₛ

ICᵢ×OCᵢ≤N_{PE}

ICᵢ, OCᵢ≤widthₜₕᵣₑₛ,

here, depthₜₕᵣₑₛ and widthₜₕᵣₑₛ represent depth resource constraint and width resource constraint of an on-chip BRAM (Block Random Access Memory), respectively.

Preferably, performing conversion further comprises (D4) performing 8-bit quantization on CNN training data, wherein a reorganized network selects 8 bits as a data quantization standard of feature mapping and kernel weight, and the 8-bit quantization is a dynamic quantization which comprises finding a best range of a data center of the feature mapping and the kernel weight data of each layer and is expressed by a formula of:

$${arg min}_{floc} {Σ ( float - fix ( floc ) )}^{2} ,$$

here, float represents an original single precision of the kernel weight or the feature mapping, fix(floc) represents a value that floc cuts float into a fixed point based on a certain fraction length.

Also, the present invention provides an OPU-based (Overlay Processing Unit-based) CNN (Convolutional Neural Network) acceleration system, which comprises:

a compile unit for performing conversion on CNN definition files of different target networks, selecting an optimal mapping strategy according to the OPU instruction set, configuring mapping, generating instructions of the different target networks, and completing the mapping; and an OPU for reading the instructions, and then running the instruction according to a parallel computing mode defined by the OPU instruction set, and completing an acceleration of the different target networks.

Preferably, the OPU comprises a read storage module, a write storage module, a calculation module, a data capture module, a data post-processing unit and an on-chip storage module, wherein the on-chip storage module comprises a feature map storage module, a kernel weight storage module, a bias storage module, an instruction storage module, and an intermediate result storage module, all of the feature map storage module, the kernel weight storage module, the bias storage module and the instruction storage module have a ping pong structure, when the ping pong structure is embodied by any storage module, other modules are loaded.

Preferably, the compile unit comprises:

a conversion unit for performing the file conversion after analyzing a form of the CNN definition files, network layer reorganization, and generation of a unified IR (Intermediate Representation);

an instruction definition unit for obtaining the OPU instruction set after defining the instructions, wherein the instructions comprises conditional instructions, unconditional instructions and an instruction granularity according to CNN network and acceleration requirements, wherein the conditional instructions comprises read storage instructions, write storage instructions, data fetch instructions, data post-processing instructions and calculation instructions; a granularity of the read storage instructions is that n numbers are read each time, here, n>1; a granularity of the write storage instructions is that n numbers are written each time, here, n>1; a granularity of the data fetch instructions is that 64 input data are simultaneously operated each time; a granularity of the data post-processing instructions is that a multiple of 64 input data are simultaneously operated each time; and a granularity of the calculation instructions is 32; and

a mapping unit for obtaining a mapping strategy corresponding to an optimal mapping strategy, expressing the mapping strategy to an instruction sequence according to the OPU instruction set, and generating instructions for different target networks, wherein:
the conversion unit comprises:
an operating unit for analyzing the CNN definition files, converting the form of the CNN definition files and compressing network information in the CNN definition files;
a reorganization unit for reorganizing all layers of a network to multiple layer groups, wherein each of the layer groups comprises a main layer and multiple auxiliary layers; and
an IR generating unit for combining the network information and layer reorganization information,
the mapping unit comprises:
a mapping strategy acquisition unit for parsing the IR, and searching a solution space according to parsed information to obtain the mapping strategy which guarantees a maximum throughput; and

an instruction generation unit for expressing the mapping strategy into the instruction sequence with the maximum throughout according to the OPU instruction set, generating the instructions of the different target networks, and completing mapping.

In summary, based on the above technical solutions, the present invention has some beneficial effects as follows.

(1) According to the present invention, after defining the OPU instruction set, CNN definition files of different target networks are converted and mapped to generate instructions of the different target networks for completing compilation, the OPU reads the instructions according to the start signal and runs the instructions according to the parallel computing mode defined by the OPU instruction set so as to achieve universal CNN acceleration, which has no need to generate specific hardware description codes for the network, no need to re-burn the FPGA, and relies on instruction configuration to complete the entire deployment process. Through defining the conditional instructions and the unconditional instructions, and selecting the parallel input and output channel computing mode to set the instruction granularity according to CNN network and acceleration requirements, the universality problem of the processor corresponding to the instruction execution set in the CNN acceleration system, and the problem that the instruction order is unable to be accurately predicted are overcome. Moreover, the communication with the off-chip data is reduced through network reorganization optimization, the optimal performance configuration is found through searching for the solution space to obtain the mapping strategy with the maximum throughput, the hardware adopts the parallel computing mode to overcome the universality of the acceleration structure. It is solved that the existing FPGA acceleration aims to generate specific individual accelerators for different CNNs, respectively, and the hardware upgrade has high complexity and poor versatility when the target networks change, thus the FPGA accelerator is not reconfigured and the acceleration effect of different network configurations is quickly achieved through instructions.

(2) The present invention defines that there are conditional instructions and unconditional instructions in the OPU instruction set, the unconditional instructions provides configuration parameters for the conditional instructions, the trigger condition of the conditional instructions is set and written in hardware, a register corresponding to the conditional instructions is set; after the trigger condition is satisfied, the conditional instructions are executed; the unconditional instructions are directly executed after being read to replace the content of the parameter register, which avoids the problem that due to the existing operation cycle has large uncertainty, the instruction ordering is unable to be predicted, and achieves the effect of accurately predicting the order of the instruction. Moreover, according to the CNN network, acceleration requirements and selected parallel input and output channels, the computing mode is determined, and the instruction granularity is set, so that the networks with different structures are mapped and reorganized to a specific structure, and the parallel computing mode is used to be adapted for the kernels of networks with different sizes, which solves the universality of the corresponding processor of the instruction set. The instruction set and the corresponding processor OPU are implemented by FPGA or ASIC (Application Specific Integrated Circuit). The OPU is able to accelerate different target CNN networks to avoid the hardware reconstruction.

(3) In the compiling process of the present invention, through the network reorganization optimization and the mapping strategy which guarantees the maximum throughput by searching the solution space, the problems of how to reduce the communication with the off-chip data, how to find the optimal performance configuration are overcome. The network is optimized and reorganized, multi-layer computing is combined and defined to achieve the maximum utilization efficiency of the computing unit. The maximum throughput solution is found in the search space, the optimal performance accelerator configuration is found, the CNN definition files of different target networks are converted and mapped to generate OPU executable instructions of different target networks, and the instructions are run according to the parallel computing mode defined by the OPU instruction set, so as to complete the rapid acceleration of different target networks.

(4) The hardware of the present invention adopts a parallel input and output channel computing mode, and in each clock cycle, reads a segment of the input channel with a size of 1×1 and a depth of ICS and the corresponding kernel elements, and uses only one data block in one round of the process, which maximizes the data localization utilization, guarantees a unified data acquisition mode of any kernel size or step size, and greatly simplifies the data management phase before calculation, thereby achieving higher frequency with less resource consumption. Moreover, the input and output channel-level parallelism exploration provides greater flexibility in resource utilization to ensure the highest generalization performance.

(5) The present invention performs 8-bit quantization on the network during conversion, which saves computing resources and storage resources.

(6) In addition to the intermediate result storage module, all the storage modules of the OPU of the present invention have a ping-pong structure; when one storage module is used, another module is loaded for overlapping the data exchange time to achieve the purpose of hiding data exchange delay, which is conducive to increasing the speed of acceleration.

### BRIEF DESCRIPTION OF THE DRAWINGS

The patent of application file contains at least one drawing executed in color. Copies of this patent or patent application publication with color drawing(s) will be provided by the Office upon request and payment of the necessary fee.

In order to more clearly illustrate technical solutions of embodiments of the present invention, the drawings used in the embodiments will be briefly described as below. It should be understood that the following drawings show only certain embodiments of the present invention and are therefore not considered as limiting the protective scope of the present invention. For those skilled in the art, other relevant drawings are also able be obtained according to these drawings without any creative work.

FIG. 1 is a flow chart of a CNN acceleration method provided by the present invention.

FIG. 2 is a schematic diagram of layer reorganization of the present invention.

FIG. 3 is a schematic diagram of a parallel computing mode of the present invention.

FIG. 4 is a structurally schematic view of an OPU of the present invention

FIG. 5 is a schematic diagram of an instruction sequence of the present invention.

FIG. 6 is a physical photo of the present invention.

FIG. 7 is a power comparison chart of the present invention.

FIG. 8 is a schematic diagram of an instruction running process of the present invention.

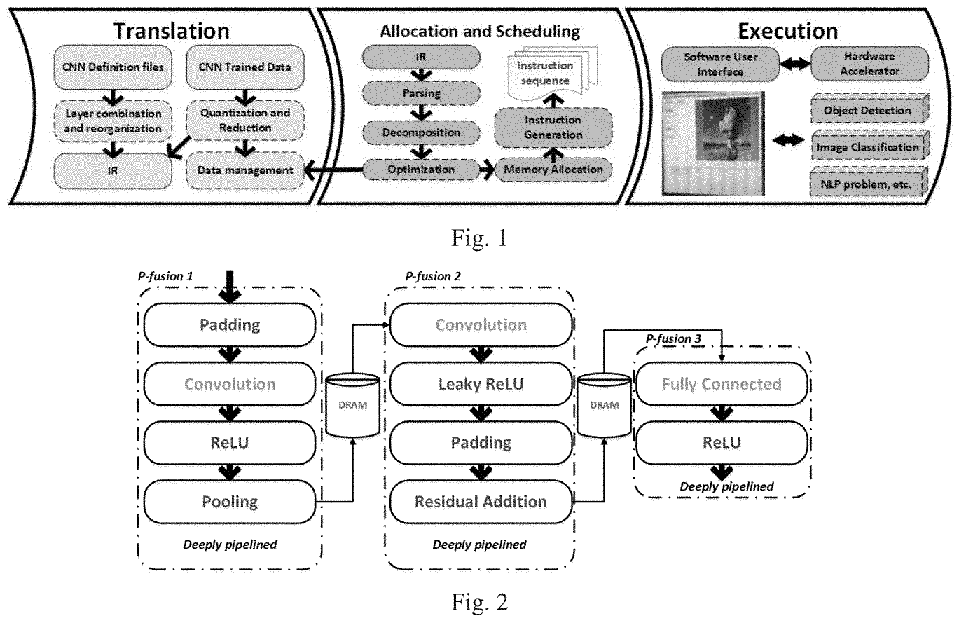

### DETAILED DESCRIPTION OF THE PREFERRED EMBODIMENT

In order to make the objects, technical solutions and advantages of the present invention more comprehensible, the present invention will be further described in detail as below with reference to the accompanying drawings and embodiments. It should be understood that the specific embodiments described herein are merely illustrative of the present invention and are not intended to limit the present invention. The components of the embodiments of the present invention, which are generally described and illustrated in the drawings herein, may be arranged and designed in a variety of different configurations.

Therefore, the following detailed description of the embodiments of the present invention is not intended to limit the protective scope but merely represents selected embodiments of the present invention. All other embodiments obtained by those skilled in the art based on the embodiments of the present invention without creative efforts are within the protective scope of the present invention.

It should be noted that the terms “first” and “second” and the like are used to distinguish one entity or operation from another entity or operation, and do not necessarily require or imply these entities or operations. There is any such actual relationship or order between them. Furthermore, the term “include”, “comprise” or any other variants thereof is intended to encompass a non-exclusive inclusion, such that a process, method, article, or device that comprises a plurality of elements includes not only those elements but also other elements, or comprises elements that are inherent to such a process, method, article, or device. An element that is defined by the phrase “comprising a . . . ” does not exclude the presence of additional equivalent elements in the process, method, article, or device that comprises the element.

The features and performance of the present invention are further described in detail with the embodiments as follows.

### FIRST EMBODIMENT

An OPU-based (Overlay Processing Unit-based) CNN (Convolutional Neural Network) acceleration method, which comprises steps of:

(1) defining an OPU instruction set;

(2) performing conversion on CNN definition files of different target networks through a complier, selecting an optimal mapping strategy according to the OPU instruction set, configuring mapping, generating instructions of the different target networks, and completing the mapping; and

(3) reading the instructions into the OPU, and then running the instruction according to a parallel computing mode defined by the OPU instruction set, and completing an acceleration of the different target networks, wherein:

the OPU instruction set comprises unconditional instructions which are directly executed and provides configuration parameters for conditional instructions and the conditional instructions which are executed after trigger conditions are met;

the conversion comprises file conversion, network layer reorganization, and generation of a unified IR (Intermediate Representation);

the mapping comprises parsing the IR, searching a solution space according to parsed information to obtain a mapping strategy which guarantees a maximum throughput, and expressing the mapping strategy into an instruction sequence according to the OPU instruction set, and generating the instructions of the different target networks.

An OPU-based (Overlay Processing Unit-based) CNN (Convolutional Neural Network) acceleration system, which comprises:

a compile unit for performing conversion on CNN definition files of different target networks, selecting an optimal mapping strategy according to the OPU instruction set, configuring mapping, generating instructions of the different target networks, and completing the mapping; and an OPU for reading the instructions, and then running the instruction according to a parallel computing mode defined by the OPU instruction set, and completing an acceleration of the different target networks.

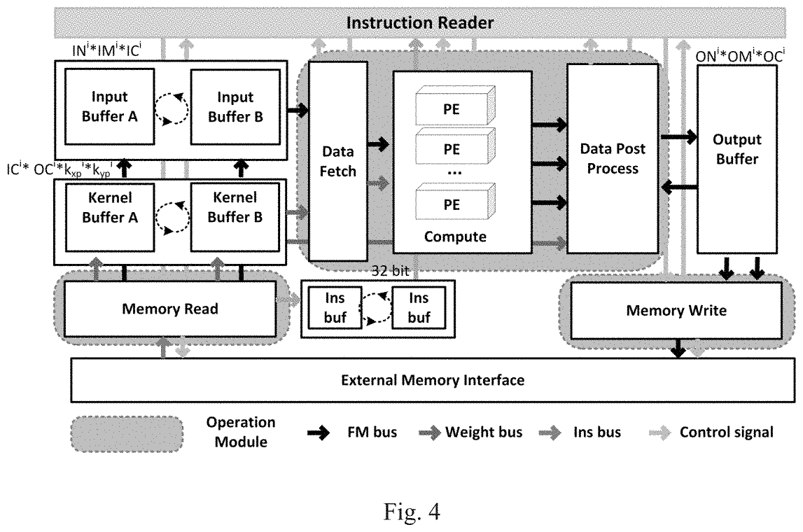

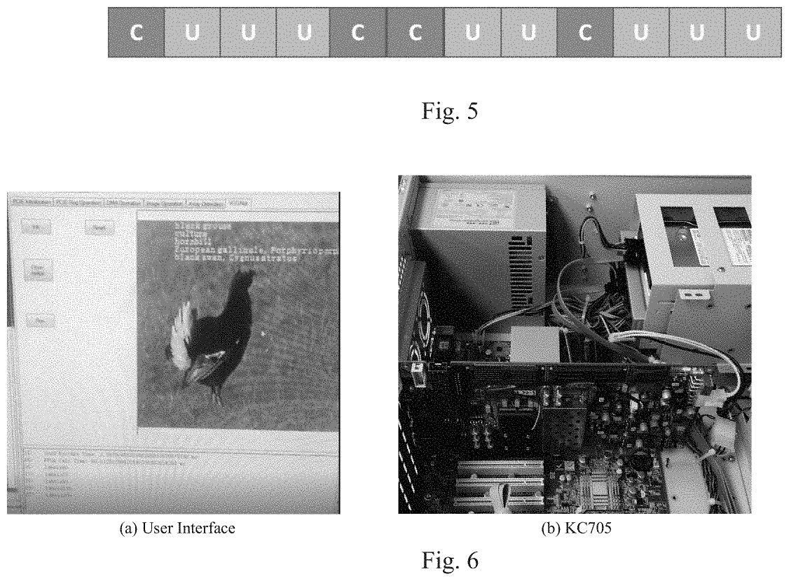

According to the type and granularity of the instructions, the FPGA-based hardware microprocessor structure is OPU, The OPU comprises five main modules for data management and calculation, and four storage and buffer modules for buffering local temporary data and off-chip storage loaded data. Pipelines between the modules are achieved, and simultaneously, there is the flow structure in the modules, so that no additional storage units are required between the operating modules. As shown in FIG. 4, the OPU comprises a read storage module, a write storage module, a calculation module, a data capture module, a data post-processing module and an on-chip storage module; The on-chip storage module comprises a feature map storage module, an inner kernel weight storage module, a bias storage module, an instruction storage module and an intermediate result storage module; all of the feature map storage module, the inner kernel weight storage, the bias storage module and the instruction storage module have a ping-pong structure, the ping-pong structure loads other modules when any one storage module is used to overlap the data exchange time, which is able to hide the data transmission delay, so that while using the data of the buffer, the other buffers are able to be refilled and updated. Therefore, the main function of mapping will not be moved from external storage to internal storage, causing the additional latency. Each input buffer of the OPU stores INi×IMi×ICi input feature map pixels, which represents the size of the ICi input channel INi×IMi rectangular sub-feature mapping, each kernel buffer holds ICi×OCi×Kx×Ky kernel weights corresponding to kernels of ICi input channel and OCi output channel. The block size and on-chip weight parameters are the main optimization factor r in layer decomposition optimization, each block of the instruction buffer caches 1024 instructions, and the output buffer holds unfinished intermediate results for subsequent rounds of calculation.

According to the first embodiment of the present invention, CNNs with 8 different architectures are mapped to the OPU for performance evaluation. A Xilinx XC7K325T FPGA module is used in KC705, the resource utilization is shown in Table 1, Xeon 5600 CPU is configured to run software converters and mappers, PCIE II is configured to send input images and read-back results. The overall experimental setup is shown in FIG. 6.

TABLE 1
FPGA Resource Utilization Table

| | LUT | Trigger FF | BRAM | DSP |
|---|---|---|---|---|
| Utilization | 133952 | 191405 | 135.5 | 516 |
| Rate | (65.73%) | (46.96%) | (30.45%) | (61.43%) |

### Network Description is as Below

YOLOV2 [22], VGG16, VGG19 [23], Inceptionv1 [24], InceptionV2, InceptionV3 [25], ResidualNet [26], ResidualNetV2 [27] are mapped to the OPU, in which YOLOV2 is the target detection network and the rest are the image classification networks. The detailed network architecture is shown in Table 2, which involves different kernel sizes from the square kernel (1×1, 3×3, 5×5, 7×7) to the spliced kernel (1×7, 7×1), various pooling layers, and special layers such as the inception layer and the residual layer. In table 2, input size indicates the input size, kernel size indicates the kernel size, pool size/pool stride indicates the pool size/the pool stride, conv layer indicates the cony layer, and FC layer indicates the FC layer, activation Type indicates the activation type and operations represent the operation.

TABLE 2
Network Information Table

| | YOLOV2 | VGG16 | VGG19 | InceptionV1 | InceptionV2 | InceptionV3 | ResidualV1 | ResidualV2 |
|---|---|---|---|---|---|---|---|---|
| Input size | 608 × 608 | 224 × 224 | 224 × 224 | 224 × 224 | 224 × 224 | 299 × 299 | 224 × 224 | 299 × 299 |
| Kernal size | 1 × 1, 3 × 3 | 3 × 3 | 3 × 3 | 1 × 1, 3 × 3, | 1 × 1, 3 × 3 | 1 × 1, 3 × 3, | 1 × 1, 3 × 3, | 1 × 1, 3 × 3, |
| | | | | 5 × 5, 7 × 7 | | 5 × 5, 1 × 3, | 7 × 7 | 7 × 7 |
| | | | | | | 3 × 1, 1 × 7, | | |
| | | | | | | 7 × 1 | | |
| Pool size/Pool stride | (2,2) | (2,2) | (2,2) | (3,2),(3,1),(7,1) | (3,2),(3,1),(7,2) | (3,2),(3,3),(8,2) | (3,2)(1,2) | (3,2)(1,2) |
| #Conv layer | 21 | 13 | 16 | 57 | 69 | 90 | 53 | 53 |
| #FC layer | 0 | 3 | 3 | 1 | 1 | 1 | 1 | 1 |
| Activation Type | Leaky [symbol] | [symbol] | [symbol] | [symbol] | [symbol] | [symbol] | [symbol] | [symbol] |
| Operations(GOP) | 54.67 | 30.92 | 39.24 | 2.99 | 3.83 | 11.25 | 6.65 | 12.65 |

[symbol]

indicates data missing or illegible when filed

### Cartographic Performance

The mapping performance is evaluated by throughput (gigabit operations per second), PE efficiency, and real-time frames per second. All designs are operated below 200 MHZ. As shown in Table 3, for any test network, the PE efficiency of all types of layers reaches 89.23% on average, and the convolutional layer reaches 92.43%. For a specific network, the PE efficiency is even higher than the most advanced customized CNN implementation method, as shown in Table 4, frequency in the table represents the frequency, throughput (GOPS) represents the index unit for measuring the computing power of the processor, PE efficiency represents the PE efficiency, conv PE efficiency represents the convolution PE efficiency, and frame/s represents frame/second.

TABLE 3
Mapping Performance Table of Different Networks

| | YOLOV2 | VGG16 | VGG319 | InceptionV1 | Inception V2 | InceptionV3 | Residual-50 | Residual-101 |
|---|---|---|---|---|---|---|---|---|
| Frequency (MHZ) | | | | | 206 | | | |
| Throughput(GOPS) | 391 | 354 | 363 | 357 | 362 | 365 | 345 | 358 |
| PE Efficiency | 95.51% | 86.50% | 88.66% | 90.03% | 89.63% | 91.31% | 84.75% | 87.85% |
| Conv PE Efficiency | 95.51% | 97.10% | 97.23% | 91.70% | 91.08% | 91.31% | 86.38% | 89.50% |
| Frame/s | 7.23 | 11.43 | 9.24 | 119.39 | 90.53 | 32.47 | 51.86 | 28.29 |

### Performance Comparison

Compared to customized FPGA compilers, FPGA-based OPUs have faster compilation and guaranteed performance. Table 4 shows a comparison with special compilers for network VGG16 acceleration; DSP number in the table represents the DSP number, frequency represents the frequency, throughput (GOPS) represents the index unit for measuring the computing power of the processor, throughput represents throughput, and PE efficiency represents the PE efficiency.

TABLE 4
Comparison table with the customized accelerator (VGG16)

| | FPGA 16[18] | FPL 17[10] | FPGA 17[28] | DAC 17[29] | DAC 17[12] | This work |
|---|---|---|---|---|---|---|
| DSP number | 780 | 1568 | 1518 | 824 | 1500 | 512 |
| Frequency 150 | 150 | 150 | 100 | 231 | 200 | |
| (MHZ) | | | | | | |
| Throughput | 136.97 | 352 | 645 | 230 | 1171 | 354 |
| (GOPS) | | | | | | |
| Throughput/DSP | 0.17 | 0.22 | 0.42 | 0.28 | 0.78 | 0.69 |
| PE Efficiency | 58% | 74% | 71% | 69% | 84% | 86% |

Since the available DSP resources on different FPGA modules are quite different, it is difficult to directly compare the throughput, so that a new indicator for each DSP's throughput is defined for better evaluation. Obviously, domain-specific designs have comparable or even better performance than the most advanced customized designs. While being compared to the domain-specific ASIC shown in Table 5, the OPU is optimized for CNN acceleration rather than general neural network operation. Therefore, the OPU is able to achieve higher PE efficiency when running CNN applications. In the table, PE number indicates the PE number, frequency indicates the frequency, throughput (GOPS) indicates the index unit for measuring the computing power of the processor, and PE efficiency indicates the PE efficiency.

Comparison Table with Specific Domains

| | | | | TPU[31] | Shidiannao | |
|---|---|---|---|---|---|---|
| VGG16 | HPCA17[30] | This work | | (CNN1) | [32] | This work |
| PE number | 256 | 512 | PE number | 65,536 | 1056 | 512 |
| Frequency | 1000 | 200 | Frequency | 700 | 1000 | 200 |
| Throughput | 340 | 354 | Throughput | 14100 | 42 | 391 |
| PE Efficiency | 66% | 86% | PE Efficiency | 31% | 3.9% | 95% |

### Power Comparison

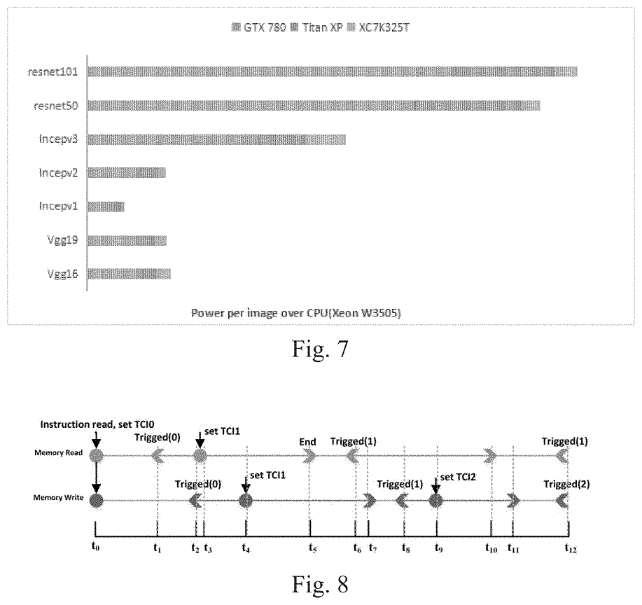

Energy efficiency is one of the main issues in edge computing applications. Here, the FPGA evaluation board kc705 is compared with the CPU Xeon W3505 running at 2.53 GHZ, the GPU Titan XP and 3840 CUDA core running at 1.58 GHZ, and the GPU GTX 780 and 2304 CUDA core running at 1 GHZ are compared. The comparison results are shown in the FIG. 7. On average, the kc705 board (2012) has a power efficiency improvement of 2.66 times compared to the prior art Nvidia Titan XP (2018).

The FPGA-based OPU is suitable for a variety of CNN accelerator applications. The processor receives network architectures from popular deep learning frameworks such as Tensorflow and Caffe, and outputs a board-level FPGA acceleration system. When a new application is needed every time, a fine-grained pipelined unified architecture is adopted instead of a new design based on the architecture template, so as to thoroughly explore the parallelism of different CNN architectures to ensure that the overall utilization exceeds 90% of computing resources in various scenarios. Because the existing FPGA acceleration aims at generating specific individual accelerators for different CNNs, respectively, the present application implements different networks for unstructured FPGAs, sets an acceleration processor, controls the OPU instructions defined in the present application, and compiles the above instructions through a compiler to generate the instruction sequence; the OPU runs the instruction according to the calculation mode defined by the instruction to implement CNN acceleration. The composition and instruction set of the system of the present application are completely inconsistent with the CNN acceleration system in the prior art. The existing CNN acceleration system adopts different methods and has different components. The hardware, system, and coverage of the present application are different from the prior art. According to the present invention, after defining the OPU instruction set, CNN definition files of different target networks are converted to generate the instructions of different target networks for completing compiling; and then the OPU reads the instructions according to the start signal, and run the instructions according to the parallel computing mode defined by the OPU instruction set to implement the general CNN acceleration, which does not require to generate specific hardware description codes for the network, and does not require to re-burn the FPGA. The entire deployment process relies on instruction configuration. Through defining the conditional instructions and the unconditional instructions, and selecting the parallel computing mode to set the instruction granularity according to CNN network and acceleration requirements, the universality problem of the processor corresponding to the instruction execution set in the CNN acceleration system, and the problem that the instruction order is unable to be accurately predicted are overcome. Moreover, the communication with the off-chip data is reduced through network reorganization optimization, the optimal performance configuration is found through searching for the solution space to obtain the mapping strategy with the maximum throughput, the hardware adopts the parallel computing mode to overcome the universality of the acceleration structure. It is solved that the existing FPGA acceleration aims to generate specific individual accelerators for different CNNs, respectively, and the hardware upgrade has high complexity and poor versatility when the target networks change, thus the FPGA accelerator is not reconfigured and the acceleration effect of different network configurations is quickly achieved through instructions.

### SECOND EMBODIMENT

Defining the OPU instruction set according to the first embodiment of th present invention is described in detail as follows.

It is necessary for the instruction set defined by the present invention to overcome the universality problem of the processor corresponding to the instruction execution instruction set. Specifically, the instruction execution time existing in the existing CNN acceleration system has great uncertainty, so that it is impossible to accurately predict the problem of the instruction sequence and the universality of the processor corresponding to the instruction set. Therefore, the present invention adopts a technical means that defining conditional instructions, defining unconditional instructions and setting instruction granularity, wherein the conditional instructions define the composition of the instruction set, the register and execution mode of the conditional instructions are set, the execution mode is that the conditional instruction is executed after satisfying the hardware programmed trigger condition, the register comprises parameter register and trigger condition register; parameter configuration mode of the conditional instruction is set and parameters are configured based on the unconditional instructions; defining the unconditional instruction comprises defining parameters and defining execution mode, the execution mode is that the unconditional instruction is directly executed, the length of the instruction is unified. The instruction set is shown in FIG. 4. Setting the instruction granularity comprises performing statistics on the CNN network and acceleration requirements, and determining the calculation mode according to statistical results and selected parallel input and output channels, so as to set the instruction granularity.

Instruction granularity for each type of instruction is set according to CNN network structure and acceleration requirements, wherein: a granularity of the read storage instructions is that n numbers are read each time, here, n>1; a granularity of the write storage instructions is that n numbers are written each time, here, n>1; a granularity of the data fetch instructions is that 64 input data are simultaneously operated each time; a granularity of the data post-processing instructions is that a multiple of 64 input data are simultaneously operated each time; and since the product of the input channel and the output channel of the network is a multiple of 32, a granularity of the calculation instructions is 32 (here, 32 is the length of the vector, including 32 8-bit data), so as to achieve reorganization of network mappings of different structures to specific structures. The computing mode is the parallel input and output channel computing mode, which is able to adjust a part of the parallel input channels through parameters for calculating more output channels at the same time, or to adjust more parallel input channels to reduce the number of calculation rounds. However, the number of the input channels and the output channels are multiples of 32 in a universal CNN structure. According to the second embodiment, in the parallel input and output channel computing mode, the minimum unit is 32 (here, 32 is the length of the vector, including 32 8-bit data) vector inner product, which is able to effectively ensure the maximum utilization of the computing unit. The parallel computing mode is used to be adapted for the kernels of networks with different sizes. In summary, the universality of the processor corresponding to the instruction set is solved.

The conditional instructions comprise read storage instructions, write storage instructions, data fetch instructions, data post-processing instructions and calculation instructions. The unconditional instructions provide parameter update, the parameters comprise length and width of the on-chip storage map module, the number of channels, the input length and width of the current layer, the number of input and output channels of the current layer, read storage operation start address, read operation mode selection, write storage operation start address, write operation mode selection, data fetch mode and constraint, setting calculation mode, setting pool operation related parameters, setting activation operation related parameters, setting data shift and cutting rounding related operations.

The trigger condition is hard written in hardware. For example, for storing the read module instructions, there are 6 kinds of instruction trigger conditions, firstly, when the last memory read is completed and the last data fetch reorganization is completed, it is triggered; secondly, when a data write storage operation is completed, the trigger is performed; thirdly, when the last data processing operation is completed, the trigger is performed, wherein the trigger conditions of the conditional instructions are set, avoiding the shortcomings of long execution time since the existing instruction sequence completely relies on the set sequence, and implementing the memory reading continuously operating in the same mode without being executed according to the fixed interval in sequence, which greatly shortens the length of the instruction sequence and further speeds up the instructions. As shown in FIG. 8, for the two operations, that is, read and write, the initial TCI is set to T0, triggering a memory to read at t1, which is executed from t1 to t5, and the TCI for the next trigger condition is able to be updated at any point between t1 and t5, storing the current TCI, which is updated by the new instruction; in this case, when the memory reading continuously operates in the same mode, no instruction is required (at time t6 and t12, the operation is triggered by the same TCI), which shortens the instruction sequence by more than 10×.

The OPU running the instructions includes steps of (1) reading the instruction block (the instruction set is a set of all instructions; the instruction block is a set of consecutive instructions, and the instruction for executing a network include multiple instruction blocks); (2) acquiring the unconditional instructions in the instruction block to directly executing, and decoding parameters included in the unconditional instructions and writing the parameters into the corresponding register; acquiring the conditional instructions in the instruction block, setting the trigger conditions according to the conditional instructions, and then jumping to the step of (3); (3) judging whether the trigger conditions are satisfied, if yes, the conditional instructions are executed; if no, the instructions are not executed; (4) determining whether the read instruction of the next instruction block included in the instructions satisfies the trigger conditions, and if yes, returning to the step of (1) to continue executing the instructions; otherwise, the trigger conditions set by the register parameters and the current condition instructions remain unchanged until the trigger conditions are met.

The read storage instructions comprises a read store operation according to mode A1 and a read store operation according to mode A2; the read store operation instruction assignable parameters include a start address, an operand count, a post-read processing mode, and an on-chip memory location.

Mode A1: Read n numbers backward from the specified address, where n is a positive integer;

Mode A2: Read n numbers according to the address stream, wherein the address in the address stream is not continuous, three kinds of readings are operated: (1) no operation after reading; (2) splicing to a specified length after reading; and (3) after reading, being divided into specified length; four reading operations on the on-chip storage location: the feature map storage module, the inner kernel weight storage module, the bias parameter storage module, and the instruction storage module.

The write storage instructions comprise a write store operation according to mode B1 and a write store operation according to mode B2; the write store operation instruction assignable parameters include a start address and an operand count.

Mode B1: Write n numbers backward from the specified address;

Mode B2: Write n numbers according to the target address stream, where the address in the address stream is not continuous;

The data fetch instructions comprise reading data operations from the on-chip feature map memory and the inner kernel weight memory according to different read data patterns and data recombination patterns, and reorganizing the read data. Data capture and reassembly operation instructions are able to be configured with parameters comprising a read feature map memory and a read inner kernel weight memory, wherein the read feature map memory comprises reading address constraints which are minimum address and maximum address, reading step size and rearrangement mode; the read inner kernel weight memory comprises reading address constraint and reading mode.

The data post-processing instructions comprise at least one of pooling, activation, fixed-point cutting, rounding, and vector-to-position addition. The data post-processing instructions are able to be configured with a pooling type, a pooling size, an activation type, and a fixed point cutting position.

The calculation instructions comprise performing a vector inner product operation according to different length vector allocations. The calculation basic unit used by the vector inner product operation is two vector inner product modules with the length of 32, and the calculation operation instruction adjustable parameters comprise the number of output results.

In summary, the unconditional instructions provide configuration parameters for the conditional instructions, the trigger conditions of the conditional instructions are set, the trigger conditions are hard written in hardware, the corresponding registers are set to the conditional instructions, and the conditional instructions are executed after the trigger conditions are satisfied, so as to achieve the read storage, write storage, data capture, data post-processing and calculation. The unconditional instruction is directly executed after being read, replacing the contents of the parameter register, and implementing the running of the conditional instructions according to the trigger conditions. The unconditional instructions provide the configuration parameter for the conditional instructions, and the instruction execution order is accurate and is not affected by other factors; at the same time, setting the trigger conditions effectively avoids the shortcoming of the long execution time since the existing instruction sequence completely relying on the set sequence, and realizes that the memory reading continuously operates in the same mode without performing the order at a fixed interval, thereby greatly shortening the length of the instruction sequence. The calculation mode is determined according to the parallel input and output channels of the CNN network and the acceleration requirement, and the instruction granularity is set to overcome the universality problem of the processor corresponding to the execution instruction set in the CNN acceleration system. After defining the OPU instruction set, the CNN definition files of different target networks are converted and mapped to the instructions of the different target networks for completing compiling, the OPU reads the instructions according to the start signal and runs the instructions according to the parallel computing mode defined by the OPU instruction set to complete the acceleration of different target networks, thereby avoiding the disadvantages of reconfiguring FPGA accelerators if existing network changes.

### THIRD EMBODIMENT

Based on the first embodiment, the compilation according to the third embodiment specifically comprises:

performing conversion on CNN definition files of different target networks, selecting an optimal mapping strategy according to the defined OPU instruction set to configure mapping, generating instructions of the different target networks, and completing mapping, wherein:

the conversion comprises file conversion, layer reorganization of network and generation of a unified intermediate representation IR;

the mapping comprises parsing the IR, searching the solution space according to the analytical information to obtain a guaranteed maximum throughput mapping strategy, and decompressing the above mapping into an instruction sequence according to the defined OPU instruction set, and generating instructions of different target networks.

A corresponding complier comprises a conversion unit for performing conversion on the CNN definition files, network layer reorganization and generating the IR; an instruction definition unit for obtaining the OPU instruction set after instruction definition, wherein the instruction definition comprises conditional instruction definition, unconditional instruction definition and instruction granularity setting according to the CNN network and acceleration requirements; and a mapping unit for after configuring a corresponding mapping with the optimal mapping strategy, decoding the corresponding mapping into an instruction sequence according to the defined OPU instruction set, and generating instructions of different target networks.

The conventional CNN comprises various types of layers that connect from top to bottom to form a complete stream, the intermediate data passed between the layers are called feature mapping, which usually requires a large storage space and is only able to be processed in an off-chip memory. Since the off-chip memory communication delay is the main optimization factor, it is necessary to overcome the problem of how to reduce the communication with off-chip data. By the layer reorganization, the main layer and the auxiliary layer are defined to reduce the off-chip DRAM access and avoid unnecessary write/read back operations. The technical solution specifically comprises steps of:

performing conversion after analyzing the form of the CNN definition files, compressing and extracting network information;

operationally reorganizing the network into multiple layer groups, wherein each layer group comprises a main layer and multiple auxiliary layers, storing results between the layer groups into the DRAM, wherein data flow between the main layer and the auxiliary layers is completed by on-chip flow, as shown in FIG. 2, the main layer comprises a convolutional layer and a fully connected layer, each auxiliary layer comprises a pooling layer, an activation layer and a residual layer; and

generating the IR according to the network information and the reorganization information, wherein: the IR comprises all operations in the current layer group, a layer index is a serial number assigned to each regular layer, a single layer group is able to have a multi-layer index for input in an initial case, in which the various previously outputted FMs are connected to form an input, and simultaneously, multiple intermediate FMs generated during the period of layer group calculation are able to be used as remaining or normal input sources for other layer groups, so as to transfer the FM sets with specific positions for being stored into the DRAM.

The conversion further comprises performing 8-bit quantization on CNN training data, wherein considering that the general network is redundant in accuracy and is complex in hardware architecture, 8 bits are selected the data quantification standard for feature mapping and kernel weigh, which is described in detail as follows.

The reorganized network selects 8 bits as the data quantization standard of feature mapping and kernel weight, that is, performs the 8-bit quantization, and the quantization is dynamic quantization, which comprises finding the minimum error point to express for feature mapping and kernel weight data center of each layer, and is expressed by a formula of:

$${arg min}_{floc} {Σ ( float - fix ( floc ) )}^{2} ,$$

here, float represents the original single precision of the kernel weight or feature mapping, fix(floc) represents a value that floc cuts float into a fixed point based on a certain fraction length.

In order to solve the problem of how to find the optimal performance configuration, or how to solve the universality of the optimal performance configuration, the solution space is found during the mapping process to obtain the mapping strategy with maximum throughput capacity, wherein the mapping process comprises:

(a1) calculating a peak theoretical value through a formula of T=f×TN_{PE},

here, T represents throughput capacity (number of operations per second), f represents working frequency, TN_{PE} represents total number of processing element (each PE performs one multiplication and one addition of chosen data representation type) available on the chip;

(a2) defining a minimum value of time L required for the entire network calculation through a formula of

$$L = {minimize}_{{α}_{i}} Σ \frac{{C}_{i}}{{α}_{i} \times T}$$

here, αᵢ represents PE efficiency of the i^{th} layer, Cᵢ represents the operational amount required to complete the i^{th} layer;

(a3) calculating the operational amount required by completing the i^{th} layer through a formula of:

Cᵢ=Nₒᵤₜⁱ×Mₒᵤₜⁱ×(2×Cᵢₙⁱ×Kᵢₙⁱ×K_{y}ⁱ−1)×Cₒᵤₜⁱ,

here, Nₒᵤₜⁱ, Mₒᵤₜⁱ, Cₒᵤₜⁱ represent output height, width and depth of corresponding layers, respectively, Cᵢₙⁱ represents depth of input layer, Kₓⁱ and K_{y}ⁱ represent kernel size of the input layer;

(a4) defining αᵢ through a formula of:

$${α}_{i} = \frac{{C}_{i}}{{t}_{i} \times {N}_{PE}} ,$$

here, tᵢ represents time required to calculate the i^{th} layer;

(a5) calculating tᵢ through a formula of:

$${t}_{i} = ceil ( \frac{{N}_{in}^{i}}{{IN}_{i}} ) \times ceil ( \frac{{M}_{in}^{i}}{{IM}_{i}} ) \times ceil ( \frac{{C}_{in}^{i}}{{IC}_{i}} ) \times ceil ( \frac{{C}_{out}^{i}}{{OC}_{i}} ) \times ceil ( \frac{{IC}_{i} \times {OC}_{i} \times {ON}_{i} \times {OM}_{i} \times {K}_{x} \times {K}_{y}}{{N}_{PE}} )$$

here, Kₓ×K_{y} represents a kernel size of the layer, ONᵢ×OMᵢ represents a size of an output block, ICᵢ×OCᵢ represents a size of an on-chip kernel block, Cᵢₙⁱ represents a depth of the input layer, Cₒᵤₜⁱ represents a depth of the output layer, Mᵢₙⁱ and Nᵢₙⁱ represent a size of the input layer, INᵢ and IMᵢ represent a size of the input block of the input layer; and

(a6) setting constraint conditions of related parameters of traversing various values of the parameters, and solving a maximum of αᵢ through a formula of:

maximize

INᵢ, IMᵢ, ICᵢ,OCᵢ αᵢ

INᵢ×IMᵢ≤depthₜₕᵣₑₛ

ICᵢ×OCᵢ≤N_{PE}

ICᵢ, OCᵢ≤widthₜₕᵣₑₛ,

here, depthₜₕᵣₑₛ and widthₜₕᵣₑₛ represent depth and width resource constraint of on-chip BRAM, respectively.

During the compilation process, the CNN definition files of different target networks are converted and mapped to generate OPU executable instructions of different target networks. Through the network reorganization optimization and the mapping strategy which guarantees the maximum throughput by searching the solution space, the problems of how to reduce the communication with the off-chip data, how to find the optimal performance configuration are overcome. The network is optimized and reorganized, multi-layer computing is combined and defined to achieve the maximum utilization efficiency of the computing unit. The maximum throughput solution is found in the search space, the optimal performance accelerator configuration is found. The to instructions executed by the OPU are compiled and outputted. The OPU reads the compiled instructions according to the start signal and runs the instructions, such as data read storage, write storage and data capture. While running the instructions, the calculation mode defined by the instruction is adopted to achieve general CNN acceleration. Therefore, there is no need to generate specific hardware description codes for the network, no need to re-burn the FPGA, and quickly realize the acceleration effect of different network configurations through instructions, which solves the problems that the existing FPGA acceleration aims at generating specific individual accelerators for different CNNs, and the hardware upgrade has high complexity and poor versatility when the target network changes.

### FOURTH EMBODIMENT

Based on the first embodiment, the second embodiment or the third embodiment, in order to solve the problem of how to ensure the universality of the acceleration structure, and maximize the data localization utilization, the hardware according to the fourth embodiment of the present invention adopts the parallel input and output channel computing mode, wherein the parallel input and output channel computing mode comprises steps of:

(C1) selecting a data block with a size of IN×IM×IC every time, reading data from an initial position from one kernel slice, wherein ICS data are read every time, and reading all positions corresponding to a first parameter of the kernel multiplied by stride x till all pixels corresponding to the initial position of the kernel are calculated; and

(C2) performing the step of (C1) for Kₓ×K_{y}×(IC/ICS)×(OC/OCS) times till all pixels corresponding to all positions of the kernel are calculated.

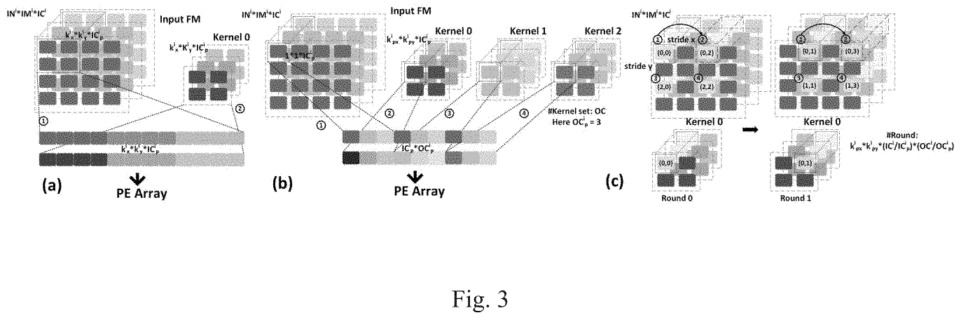

Traditional design tends to explore parallelism in a single kernel. Although the kernel parallelism is the most direct level, it has two drawbacks of complex FM data management and poor generalization between various kernel sizes. FM data are usually stored in rows or columns, as shown in FIG. 3(a), extending the Kx×Ky kernel size of FM means reading row and column direction data in a single clock cycle, which raises a huge challenge for the limited bandwidth of the block RAM, and often requires additional complex data reuse management to complete. In addition, the data management logic designed for one kernel size is unable to be effectively applied to another kernel size. A similar situation occurs in PE array designs, and the PE architecture optimized for a certain Kx×Ky kernel size may not be suitable for other kernel sizes. That's why many traditional FPGAs are popular for being optimized on a 3×3 kernel size and perform best on the network with the 3×3 kernel size.

To solve the above problem, a higher level of parallelism is explored and a computing mode which is able to achieve the highest efficiency regardless of the kernel size is adopted. FIG. 3(b) illustrates the working principle of the computing mode as follows. At each clock cycle, reading a fragment of a depth ICS input channel with a size of 1×1 and the corresponding kernel elements which conform to the natural data storage mode and only require very small bandwidths. The parallelism is achieved in the input channel (ICS) and the output channel (OCS, the number of kernel sets involved). FIG. 3(c) further illustrates the computing process. For the 0^{th} cycle 0, reading the input channel slice of a position (0, 0) of the kernel, jumping the stride x and reading a position (0, 2) of the kernel in the next cycle, continuously reading till all pixels corresponding to the position (0, 0) of the kernel are calculated; and then entering the first round and reading all pixels corresponding to the position (0, 1) of the kernel starting from the position (0, 1) of the kernel. In order to compute the data block with the size of IN×IM×IC with the OC set kernel, the above step needs to be performed for Kₓ×K_{y}×(IC/ICS)×(OC/OCS) rounds. The parallel computing mode is commonly used in CNN acceleration, and the difference between different designs is that the selected parallel mode is different.

The calculation module in the OPU considers the granularity defined by the instruction, wherein the basic calculation unit is configured to calculate the inner product of two vectors with the length of 32 (here, each vector has the length of 32 and comprises 32 8-bit data), and the basic calculation unit comprises 16 DSPs (Digital Signal Processors) and an addition tree structure, in which each DSP comprises two 8-bit×8-bit multipliers, so as to realize the function of A×(B+C), here, A refers to feature map data, B and C correspond to two parameter data of the output channel inner product, respectively. The calculation module comprises 32 basic calculation units, which is able to complete the sum of inner products of two vectors with the length of 1024, and is also able to complete the sum of inner products of 32 vectors with the length of 32, or the sum of inner products of 32/n vectors with the length of 32×n, here, n is an integer.

The hardware provided by the present invention adopts the parallel input and output channel computing mode to read a fragment of the depth ICS input channel with a size of 1×1 and corresponding kernel elements in each clock cycle, which only uses one data block in one round of the process, so that the data localization utilization is maximized, thereby ensuring a unified data acquisition mode of any kernel size or step size, greatly simplifying the data management phase before calculation, and achieving higher frequencies with less resource consumption. Moreover, the input and output channel-level parallelism exploration provides greater flexibility for resource utilization and ensures the highest generalization performance.

The above are only the preferred embodiments of the present invention, and are not intended to limit the present invention. Any modifications, equivalent substitutions and improvements made within the spirit and principles of the present invention are intended to be included within the protective scope of the present invention.

What is claimed is:

1. An OPU-based (Overlay Processing Unit-based) CNN (Convolutional Neural Network) acceleration method, which comprises steps of:
(1) defining an OPU instruction set to optimize an instruction granularity according to CNN network research results and acceleration requirements;
(2) performing conversion on CNN definition files of different target networks through a complier, selecting an optimal mapping strategy according to the OPU instruction set, configuring mapping, generating instructions of the different target networks, and completing the mapping; and
(3) reading the instructions into the OPU, and then running the instruction according to a parallel computing mode defined by the OPU instruction set, and completing an acceleration of the different target networks, wherein:
the OPU instruction set comprises unconditional instructions which are directly executed and provides configuration parameters for conditional instructions and the conditional instructions which are executed after trigger conditions are met;
the conversion comprises file conversion, network layer reorganization, and generation of a unified IR (Intermediate Representation);
the mapping comprises parsing the IR, searching a solution space according to parsed information to obtain a mapping strategy which guarantees a maximum throughput, and expressing the mapping strategy into an instruction sequence according to the OPU instruction set, and generating the instructions of the different target networks.

2. The OPU-based CNN acceleration method, as recited in claim 1, wherein: the step of defining the OPU instruction set comprises defining the conditional instructions, defining the unconditional instructions and setting the instruction granularity, wherein:
defining conditional instructions comprises:
(A1) building the conditional instructions, wherein the conditional instructions comprise read storage instructions, write storage instructions, data fetch instructions, data post-processing instructions and calculation instructions;
(A2) setting a register unit and an execution mode of each of the conditional instructions, wherein the execution mode is that each of the conditional instructions is executed after a hardware programmed trigger condition is satisfied, and the register unit comprises a parameter register and a trigger condition register; and
(A3) setting a parameter configuration mode of each of the conditional instructions, wherein the parameter configuration mode is that the parameters are configured according to the unconditional instructions;
defining the unconditional instructions comprises:
(B1) defining parameters of the unconditional instructions; and
(B2) defining an execution mode of each of the unconditional instructions, wherein the execution mode is that the unconditional instructions are directly executed after being read.

3. The OPU-based CNN acceleration method, as recited in claim 2, wherein: setting the instruction granularity comprises setting a granularity of the read storage instructions that n numbers are read each time, here, n>1; setting a granularity of the write storage instructions that n numbers are written each time, here, n>1; setting a granularity of the data fetch instructions to a multiple of 64, which means that 64 input data are simultaneously operated; setting a granularity of the data post-processing instructions to a multiple of 64; and setting a granularity of the calculation instructions to 32.

4. The OPU-based CNN acceleration method, as recited in claim 1, wherein: the parallel computing mode comprises steps of:
(C1) selecting a data block with a size of IN×IM×IC every time, reading data from an initial position from one kernel slice, wherein ICS data are read every time, and reading all positions corresponding to a first parameter of the kernel multiplied by stride x till all pixels corresponding to the initial position of the kernel are calculated; and
(C2) performing the step of (C1) for Kx×Ky×(IC/ICS)×(OC/OCS) times till all pixels corresponding to all positions of the kernel are calculated.

5. The OPU-based CNN acceleration method, as recited in claim 2, wherein: the parallel computing mode comprises steps of:
(C1) selecting a data block with a size of IN×IM×IC every time, reading data from an initial position from one kernel slice, wherein ICS data are read every time, and reading all positions corresponding to a first parameter of the kernel multiplied by stride x till all pixels corresponding to the initial position of the kernel are calculated; and
(C2) performing the step of (C1) for Kx×Ky×(IC/ICS)×(OC/OCS) times till all pixels corresponding to all positions of the kernel are calculated.

6. The OPU-based CNN acceleration method, as recited in claim 3, wherein: the parallel computing mode comprises steps of:
(C1) selecting a data block with a size of IN×IM×IC every time, reading data from an initial position from one kernel slice, wherein ICS data are read every time, and reading all positions corresponding to a first parameter of the kernel multiplied by stride x till all pixels corresponding to the initial position of the kernel are calculated; and
(C2) performing the step of (C1) for Kx×Ky×(IC/ICS)×(OC/OCS) times till all pixels corresponding to all positions of the kernel are calculated.

7. The OPU-based CNN acceleration method, as recited in claim 1, wherein: performing conversion comprises:
(D1) performing the file conversion after analyzing a form of the CNN definition files, compressing and extracting network information of the CNN configuration files;
(D2) performing network layer reorganization, obtaining multiple layer groups, wherein each of the layer groups comprises a main layer and multiple auxiliary layers, storing results between the layer groups into a DRAM (Dynamic Random Access Memory), wherein data flow between the main layer and the auxiliary layers is completed by on-chip flow, the main layer comprises a convolutional layer and a fully connected layer, each of the auxiliary layers comprises a pooling layer, an activation layer and a residual layer; and
(D3) generating the IR according to the network information and reorganization information.

8. The OPU-based CNN acceleration method, as recited in claim 1, wherein: searching the solution space according to parsed information to obtain the mapping strategy which guarantees the maximum throughput of the mapping comprises:
(E1) calculating a peak theoretical value through a formula of T=f×TN_{PE},
here, T represents a throughput capacity that is a number of operations per second, f represents a working frequency, TN_{PE} represents a total number of processing element (each PE performs one multiplication and one addition of chosen data representation type) available on a chip;
(E2) defining a minimum value of time L required for an entire network calculation through a formula of:
$$L = {minimize}_{{α}_{i}} Σ \frac{{C}_{i}}{{α}_{i} \times T} ,$$
here, αᵢ represents a PE efficiency of an i^{th} layer, Cᵢ represents an operational amount required to complete the i^{th} layer;
(E3) calculating the operational amount required to complete the i^{th} layer through a formula of:
Cᵢ=Nₒᵤₜⁱ×Mₒᵤₜⁱ×(2×Cᵢₙⁱ×Kᵢₙⁱ×K_{y}ⁱ−1)×Cₒᵤₜⁱ,
here, Nₒᵤₜⁱ, Mₒᵤₜⁱ, Cₒᵤₜⁱ represent output height, width and depth of corresponding layers, respectively, Cᵢₙⁱ represents a depth of an input layer, Kₓⁱ and K_{y}ⁱ represent kernel sizes of the input layer, respectively;
to (E4) defining αᵢ through a formula of:
$${α}_{i} = \frac{{C}_{i}}{{t}_{i} \times {N}_{PE}} ,$$
here, tᵢ represents time required to calculate the i^{th} layer;
(E5) calculating tᵢ through a formula of:
$${t}_{i} = ceil ( \frac{{N}_{in}^{i}}{{IN}_{i}} ) \times ceil ( \frac{{M}_{in}^{i}}{{IM}_{i}} ) \times ceil ( \frac{{C}_{in}^{i}}{{IC}_{i}} ) \times ceil ( \frac{{C}_{out}^{i}}{{OC}_{i}} ) \times ceil ( \frac{{IC}_{i} \times {OC}_{i} \times {ON}_{i} \times {OM}_{i} \times {K}_{x} \times {K}_{y}}{{N}_{PE}} )$$
here, Kx×Ky represents a kernel size of the input layer, ONᵢ×OMᵢ represents a size of an output block, ICᵢ×OCᵢ represents a size of an on-chip kernel block, Cᵢₙⁱ represents the depth of the input layer, Cₒᵤₜⁱ represents the depth of the output layer, Mᵢₙⁱ and Nᵢₙⁱ represent sizes of the input layer, INᵢ and IMᵢ represent size of the input block of the input layer; and
(E6) setting constraint conditions of related parameters of αᵢ, traversing various values of the parameters, and solving a maximum value of αᵢ through a formula of:
maximize
INᵢ, IMᵢ, ICᵢ, OCᵢ αᵢ
INᵢ×IMᵢ≤depthₜₕᵣₑₛ
ICᵢ×OCᵢ≤N_{PE}
ICᵢ, OCᵢ≤widthₜₕᵣₑₛ,
here, depthₜₕᵣₑₛ and widthₜₕᵣₑₛ represent depth resource constraint and width resource constraint of an on-chip BRAM (Block Random Access Memory), respectively.

9. The OPU-based CNN acceleration method, as recited in claim 7, wherein: performing conversion further comprises (D4) performing 8-bit quantization on CNN training data, wherein a reorganized network selects 8 bits as a data quantization standard of feature mapping and kernel weight, and the 8-bit quantization is a dynamic quantization which comprises finding a best range of a data center of the feature mapping and the kernel weight data of each layer and is expressed by a formula of:
$${arg min}_{floc} {Σ ( float - fix ( floc ) )}^{2} ,$$
here, float represents an original single precision of the kernel weight or the feature mapping, fix(floc) represents a value that floc cuts float into a fixed point based on a certain fraction length.

10. An OPU-based (Overlay Processing Unit-based) CNN (Convolutional Neural Network) acceleration system, which comprises:
a compile unit for performing conversion on CNN definition files of different target networks, selecting an optimal mapping strategy according to the OPU instruction set, configuring mapping, generating instructions of the different target networks, and completing the mapping; and
an OPU for reading the instructions, and then running the instruction according to a parallel computing mode defined by the OPU instruction set, and completing an acceleration of the different target networks.

11. The OPU-based CNN acceleration system, as recited in claim 10, wherein: the OPU comprises a read storage module, a write storage module, a calculation module, a data capture module, a data post-processing unit and an on-chip storage module, wherein the on-chip storage module comprises a feature map storage module, a kernel weight storage module, a bias storage module, an instruction storage module, and an intermediate result storage module, all of the feature map storage module, the kernel weight storage module, the bias storage module and the instruction storage module have a ping pong structure, when the ping pong structure is embodied by any storage module, other modules are loaded.

12. The OPU-based CNN acceleration system, as recited in claim 10, wherein: the compile unit comprises:
a conversion unit for performing the file conversion after analyzing a form of the CNN definition files, network layer reorganization, and generation of a unified IR (Intermediate Representation);
an instruction definition unit for obtaining the OPU instruction set after defining the instructions, wherein the instructions comprises conditional instructions, unconditional instructions and an instruction granularity according to CNN network and acceleration requirements, wherein the conditional instructions comprises read storage instructions, write storage instructions, data fetch instructions, data post-processing instructions and calculation instructions; a granularity of the read storage instructions is that n numbers are read each time, here, n>1; a granularity of the write storage instructions is that n numbers are written each time, here, n>1; a granularity of the data fetch instructions is that 64 input data are simultaneously operated each time; a granularity of the data post-processing instructions is that a multiple of 64 input data are simultaneously operated each time; and a granularity of the calculation instructions to 32; and
a mapping unit for obtaining a mapping strategy corresponding to an optimal mapping strategy, expressing the mapping strategy to an instruction sequence according to the OPU instruction set, and generating instructions for different target networks, wherein:
the conversion unit comprises:
an operating unit for analyzing the CNN definition files, converting the form of the CNN definition files and compressing network information in the CNN definition files;
a reorganization unit for reorganizing all layers of a network to multiple layer groups, wherein each of the layer groups comprises a main layer and multiple auxiliary layers; and
an IR generating unit for combining the network information and layer reorganization information,
the mapping unit comprises:
a mapping strategy acquisition unit for parsing the IR, and searching a solution space according to parsed information to obtain the mapping strategy which guarantees a maximum throughput; and
an instruction generation unit for expressing the mapping strategy into the instruction sequence with the maximum throughout according to the OPU instruction set, generating the instructions of the different target networks, and completing mapping.
